(19) United States
(12) Patent Application Publication
(10) Pub. No.: US 2004/0105458 A1
(43) Pub. Date: Jun. 3, 2004

(54) Communication control method, server apparatus, and client apparatus

(75) Inventor: Yasushi Ishizuka, Hamura-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/721,377

(22) Filed: Nov. 26, 2003

(30) Foreign Application Priority Data
Nov. 29, 2002 (JP) 2002-347501

(51) Int. Cl. H04L 12/413

(52) U.S. Cl. 370/445; 370/493; 370/447

(57) ABSTRACT

There is provided a server apparatus that is connectable to client apparatuses via a radio transmission medium. The server apparatus includes a storage unit storing list data indicating a priority order of the client apparatuses in allocating an exclusive period thereto, the exclusive period being a period in which exclusive use of the radio transmission medium is permitted, a control unit configured to allocate the exclusive period to the client apparatuses in accordance with the priority order indicated by the list data, and a processing unit configured to rearrange the priority order of the client apparatuses on the list data using situation data indicating a situation of one of the client apparatuses, when the situation data is transmitted from the one.

### CROSS-REFERENCE TO RELATED APPLICATIONS

This application is based upon and claims the benefit of priority from the prior Japanese Patent Application No. 2002-347501, filed Nov. 29, 2002, the entire contents of which are incorporated herein by reference.

### BACKGROUND OF THE INVENTION

1. Field of the Invention

The present invention relates to a communication control method for controlling communication carried out among a plurality of apparatuses, a server apparatus, and a client apparatus.

2. Description of the Related Art

As a method of using a short-distance radio technique to transmit/receive data between a server apparatus (AP) and client apparatus (STATION), a plurality of methods are considered. For example, in IEEE 802.11 that is a typical wireless LAN standard, two methods can be used as a method of carrying out communication.

One is a method referred to as a distributed coordination function (DCF). In this method, a client apparatus that desires to transmit data checks that a radio transmission medium for first use in data transmission is not used by any other apparatus (a state in which there is no competition). After confirming that the medium is not used, the data is transmitted. However, in this method, the data cannot be transmitted until it is confirmed that the radio transmission medium is not used. Therefore, it is not guaranteed that the data can necessarily be transmitted/received within a given period.

Another method is referred to as a point coordination function (PCF). In this method, a server apparatus carries out central management of the client apparatus in a connection relation. When this method is used, the client apparatus desiring the central management by the server apparatus issues a request for management by the PCF with respect to the server apparatus beforehand. The server apparatus holds list data of the client apparatuses whose requests have been accepted, and permits the client apparatuses described in the list data to exclusively use the radio transmission medium for each given period. Accordingly, it can be guaranteed to some degree that the data can be transmitted in the given period. Even when it is necessary to continuously transmit/receive the data such as dynamic image data without any delay, the data can efficiently be transmitted/received.

Additionally, as a method for enhancing a quality level of a communication service, for example, there is a method described in Japanese Patent No. 2955287. According to this document, for QoS adjustment, a QoS management division of a stream agent generated for each communication stream compares a resource amount with a threshold value, and adjusts the resource amount of the stream in accordance with the result.

As described above, when the radio transmission technique is used to efficiently transmit/receive the data (the data is transmitted/received within the given period), the server apparatus needs to use a method of executing the central management of the client apparatuses to allocate the radio transmission mediums for the exclusive use to the respective client apparatuses.

However, an order of priority of each client apparatus registered in the list data managed by the server apparatus is not basically updated, while the server apparatus has the connection relation with the client apparatuses. Therefore, when situations of the client apparatuses change (e.g., there is a large change in a necessary transmission/reception data amount), there occurs a problem that the data cannot efficiently be transmitted/received using the radio transmission medium.

### BRIEF SUMMARY OF THE INVENTION

Embodiments of the present invention may provide a communication control method, server apparatus, and client apparatus in which communication using a radio transmission medium can efficiently be carried out even with a change of a situation of a client apparatus.

According to one aspect of the present invention, there is provided a server apparatus connectable to client apparatuses via a radio transmission medium, comprising a storage unit storing list data indicating a priority order of the client apparatuses in allocating an exclusive period thereto, the exclusive period being a period in which exclusive use of the radio transmission medium is permitted; a control unit configured to allocate the exclusive period to the client apparatuses in accordance with the priority order indicated by the list data; and a processing unit configured to rearrange the priority order of the client apparatuses on the list data using situation data indicating a situation of one of the client apparatuses, when the situation data is transmitted from the one.

According to another aspect of the present invention, there is provided a client apparatus connectable to a server apparatus via a radio transmission medium, comprising a permission request unit configured to request the server apparatus for permission of exclusive use of the radio transmission medium by the client apparatus; and a situation notification unit configured to transmit situation data indicating a situation of one of the client apparatuses to the server apparatus, after the server apparatus admits the permission.

According to still another aspect of the present invention, there is provided a communication control method for use in a server apparatus connectable to client apparatuses via a radio transmission medium, comprising storing in the server apparatus list data indicating a priority order of the client apparatuses in allocating an exclusive period thereto, the exclusive period being a period in which exclusive use of the radio transmission medium is permitted; executing a control to allocate the exclusive period to the client apparatuses in accordance with the priority order indicated by the list data; and rearranging the priority order of the client apparatuses on the list data using situation data indicating a situation of one of the client apparatuses, when the situation data is transmitted from the one.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a constitution of a communication system according to one embodiment of the present invention;

FIG. 2 is an explanatory view of intervals of PCF and DCF;

FIG. 3 is a diagram showing one example of list data (major part) held by a server apparatus;

FIG. 4 is an explanatory view of exclusive intervals of the respective client apparatuses determined based on the list data of FIG. 3;

FIGS. 5A and 5B are block diagrams showing constitutions of the server apparatus and client apparatus;

FIG. 6 is a diagram showing one example of type data (apparatus type information);

FIG. 7 is a diagram showing one example of the list data held by the server apparatus;

FIGS. 8A and 8B are diagrams showing allocation of the list data and exclusive intervals before update;

FIGS. 9A and 9B are diagrams showing the allocation of the list data and exclusive intervals after the update;

FIG. 10 is a flowchart showing a flow of a list data addition process in a connection process;

FIG. 11 is a flowchart showing the flow of a list data deletion process in a disconnection process;

FIG. 12 is a flowchart showing the flow of a situation data transmission process of the client apparatus;

FIG. 13 is a flowchart showing the flow of a situation data reception process of the server apparatus; and

FIG. 14 is a flowchart showing the flow of an order change process of the list data.

### DETAILED DESCRIPTION OF THE INVENTION

Embodiments of the present invention will be described below with reference to the drawings.

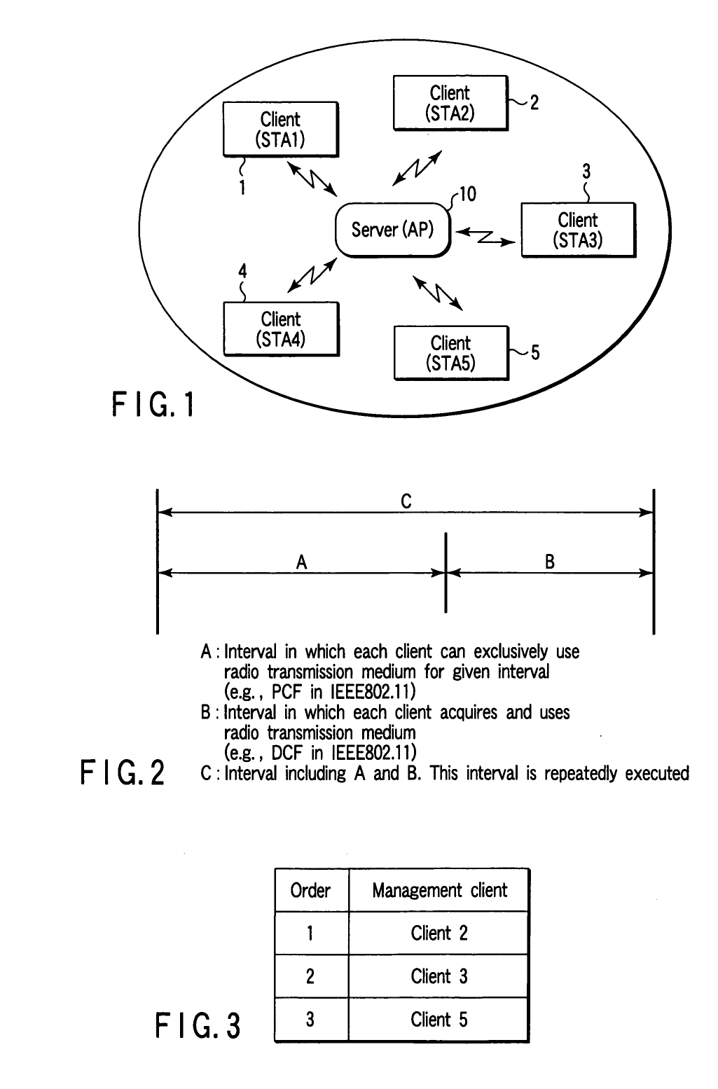

FIG. 1 is a diagram showing a constitution of a communication system according to one embodiment of the present invention.

The communication system includes a single server apparatus (AP) 10 and a plurality of client apparatuses (STA1 to STA5) 1 to 5.

The server apparatus 10 and client apparatuses 1 to 5 can use a short-distance radio technique conforming to a wireless LAN standard IEEE 802.11 to mutually transmit/receive data. As communication methods, methods referred to as a distributed coordination function (DCF) and a point coordination function (PCF) defined in IEEE 802.11 are applied.

In the DCF, the client apparatus that desires to transmit the data checks that a radio transmission medium first for use in data transmission is not used by any other apparatus (a state without any competition), and transmits the data after confirming that the medium is not used.

In the PCF, the server apparatus 10 executes central management with respect to the client apparatus in a connection relation (client apparatuses 2, 3, 5). When this method is used, the client apparatus that desires the central management by the server apparatus 10 issues a request for management by the PCF with respect to the server apparatus 10 beforehand. The server apparatus 10 holds list data of the client apparatuses whose requests have been accepted, and permits the client apparatuses described in the list data to exclusively use the radio transmission medium for each given period.

FIG. 2 is an explanatory view of intervals (time periods) of the PCF and DCF defined in the IEEE 802.11.

In the drawing, an interval A corresponds to the interval of the PCF, in which each client apparatus can exclusively use the radio transmission medium for a given interval. An interval B corresponds to the interval of the DCF, in which each client apparatus acquires and uses the radio transmission medium. An interval C is a combination of the intervals A and B, and in operation, this interval C is repeated.

FIG. 3 is a diagram showing one example of list data (major part) held by the server apparatus 10.

In the drawing, a list data example is shown in a case in which the server apparatus 10 is connected to the client apparatuses 1 to 5 and the client apparatuses 2, 3, 5 are permitted to exclusively use the radio transmission medium under central management by the server apparatus 10. In this example, a priority order in allocating an exclusive period to each client apparatus is an order of the client apparatuses 2, 3, 5.

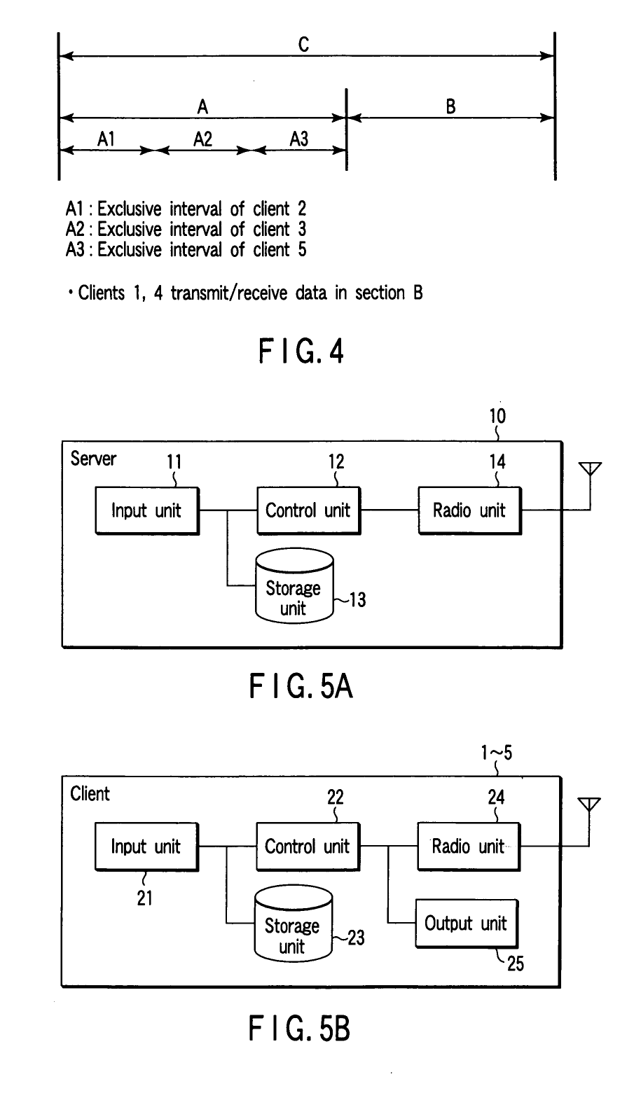

FIG. 4 is an explanatory view of the exclusive intervals of the respective client apparatuses determined based on the list data of FIG. 3.

FIG. 4 shows details of the interval A in FIG. 2 described above. That is, in the interval A in FIG. 4, first an exclusive interval A1 of the client apparatus 2 whose priority order is 1 is disposed. Thereafter, an exclusive interval A2 of the client apparatus 3 whose priority order is 2 is disposed. Finally, an exclusive interval A3 of the client apparatus 5 whose priority order is 3 is disposed.

Note that, when the client apparatuses 1, 4 transmit/receive the data, interval “B” is used.

In the present embodiment, for example, there is assumed an application to a household network for connecting the server apparatus 10 such as a home server in a household to the client apparatuses 1 to 5 including AV apparatuses such as TV, PC, electrical household appliances such as a refrigerator and laundry machine, and anticrime apparatuses such as a camera. In this case, it is considered that the amount of data to be transmitted/received largely differs with the type of the client apparatus.

For example, when TV recorded programs accumulated in the home server constituting the server apparatus 10 are transmitted into a large-screen monitor constituting the client apparatus, and watched, the large-screen monitor constantly requires a data amount by a unit of Mbps in order to receive the data from the home server. On the other hand, when information is exchanged in order to manage a state of the refrigerator by the home server, a data amount by a unit of several kbps is sufficient. There are also: apparatuses such as a personal computer (PC) in which the amount of the data to be transmitted/received largely changes to several Mbps from several kbps depending on a situation of an application for use; and apparatuses such as the camera installed in an entrance in which the data amount becomes large only in transmitting photographed video to the home server and usually the data amount to be transmitted/received is close to 0 because there is not any data to be transmitted.

In this manner, in the household network, it is sufficiently considered that the amount of the data to be transmitted/received with respect to the server apparatus 10 largely changes with the type of the client apparatus or the situation of the apparatus. Therefore, in the present embodiment, in a method of transmitting/receiving the data in the central management by the server apparatus 10 in order to efficiently transmit/receive the data as in the above-described PCF, a mechanism is disposed in which management data of each client apparatus in the server apparatus 10 can flexibly be updated by the type or the situation of the apparatus. Especially in the present embodiment, there is disposed an update process function of flexibly updating client apparatus management data (list data) held in the server apparatus 10 in accordance with the situation of the client apparatus, when the server apparatus 10 executes the central management of the transmission/reception of the data.

FIG. 5A is a block diagram showing a constitution of the server apparatus 10 according to the present embodiment.

The server apparatus 10 includes an input unit 11, control unit 12, storage unit 13, and radio unit 14.

The input unit 11 corresponds to input devices such as a keyboard, mouse, remote controller, and touch pad, and is used for inputting various information to operate the apparatus.

The control unit 12 executes a control of the whole apparatus, and includes not only a transmission/reception process function of using a radio function to transmit/receive the data but also a control function for exclusive use of referring to the list data to permit the respective client apparatuses in order from a higher priority order to exclusively use the radio transmission medium in preference. The control unit 12 also includes: a recording process function of acquiring type data indicating the type of the server apparatus to record the data in the list data; and an update process function of acquiring situation data indicating the situation of the client apparatus transmitted from any client apparatus if any to record the data in the list data, and rearranging the priority order of each client apparatus on the list data based on the situation data and type data.

The storage unit 13 stores various types of information in the apparatus, received data, and the like. For example, the storage unit 13 stores the list data indicating the priority order of each client apparatus in allocating the exclusive period to each client apparatus permitted to exclusively use the radio transmission medium.

The radio unit 14 uses the short-distance radio technique such as IEEE 802.11 to transmit/receive the data.

FIG. 5B is a block diagram showing constitutions of the client apparatuses 1 to 5 according to the embodiment.

Each client apparatus includes an input unit 21, control unit 22, storage unit 23, radio unit 24, and output unit 25.

The input unit 21 corresponds to the input devices such as the keyboard, mouse, remote controller, and touch pad, and is used for inputting various information to operate the apparatus.

The control unit 22 executes the control of the whole apparatus, and carries out a transmission/reception process of the data using the radio function. The control unit 22 includes: a permission request function of transmitting the type data indicating type of the client apparatus to request the server apparatus 10 for permission of the exclusive use of the radio transmission medium by the client apparatus; and also a situation notification function of collecting situation data indicating the situation of the own apparatus if necessary after recognizing the permission by the server apparatus 10, and transmitting the situation data to the server apparatus 10.

The storage unit 23 stores various types of information in the apparatus, received data, and the like.

The radio unit 24 uses the short-distance radio technique such as IEEE 802.11 to transmit/receive the data.

The output unit 25 corresponds to devices such as a display and speaker, and outputs the data as an image and sound.

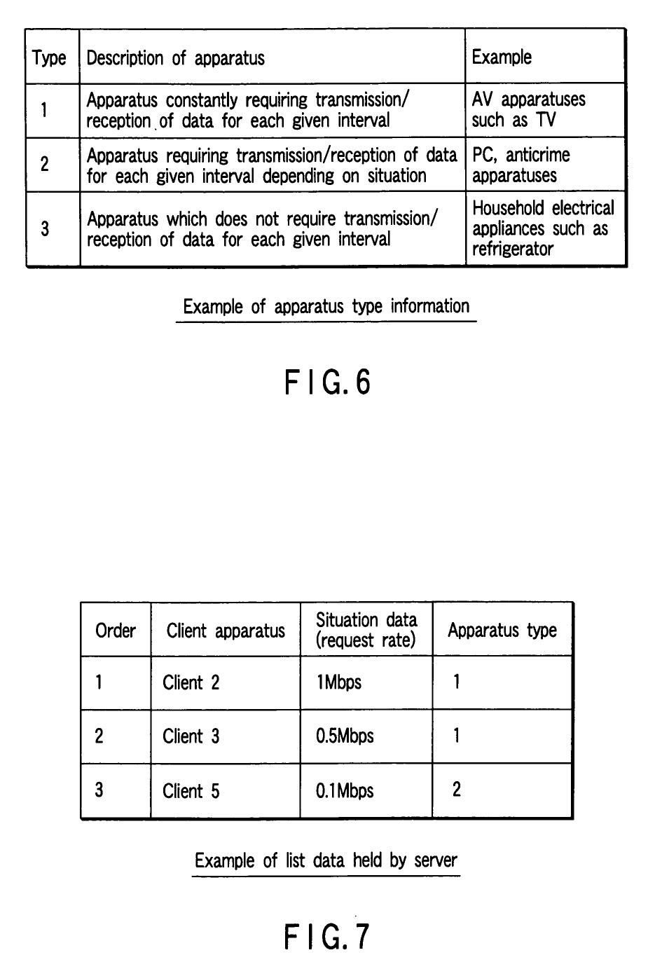

FIG. 6 is a diagram showing one example of the type data (apparatus type information).

In the drawing, “TYPE 1” corresponds to the apparatus that constantly requires the transmission/reception of the data for each given interval, and corresponds, for example, to AV apparatuses such as TV. “TYPE 2” corresponds to the apparatus that requires the transmission/reception of the data for each given interval depending on the situation, and corresponds, for example, to PC and anticrime apparatuses. “TYPE 3” corresponds to the apparatus that does not require the transmission/reception of the data for each given interval, and corresponds, for example, to household electrical appliances such as a refrigerator. In this case, the priority order tends to be set to an order of “TYPE 1”, “TYPE 2”, “TYPE 3”.

FIG. 7 is a diagram showing one example of the list data held by the server apparatus 10.

Note that the “situation data” in the list data indicates, for example, a transfer rate (e.g., request rate) required by the client apparatus.

In the list data of the drawing, the client apparatuses 2, 3, 5 are registered as the apparatuses permitted to exclusively use the radio transmission medium for the given interval in the PCF interval.

Here, the client apparatuses 2, 3 correspond to the “TYPE 1”, and the client apparatus 5 corresponds to the “TYPE 2”. It is also assumed that the request rate of the client apparatus 2 is “1 Mbps”, that of the client apparatus 3 is “0.5 Mbps”, and that of the client apparatus 5 is “0.1 Mbps”.

The server apparatus 10 determines the above-described priority order, for example, based on a combination of the type data and situation data (e.g., request rate). In the example of FIG. 7, when priority is judged from a viewpoint of the “type data”, the client apparatuses 2, 3 take priority over the client apparatus 5. When the priority is judged with respect to the same type of client apparatuses 2, 3 from a viewpoint of the “request rate”, the client apparatus 2 takes priority over the client apparatus 3. Therefore, in this case, the priority order on the list data is set to an order of the client apparatuses 2, 3, 5.

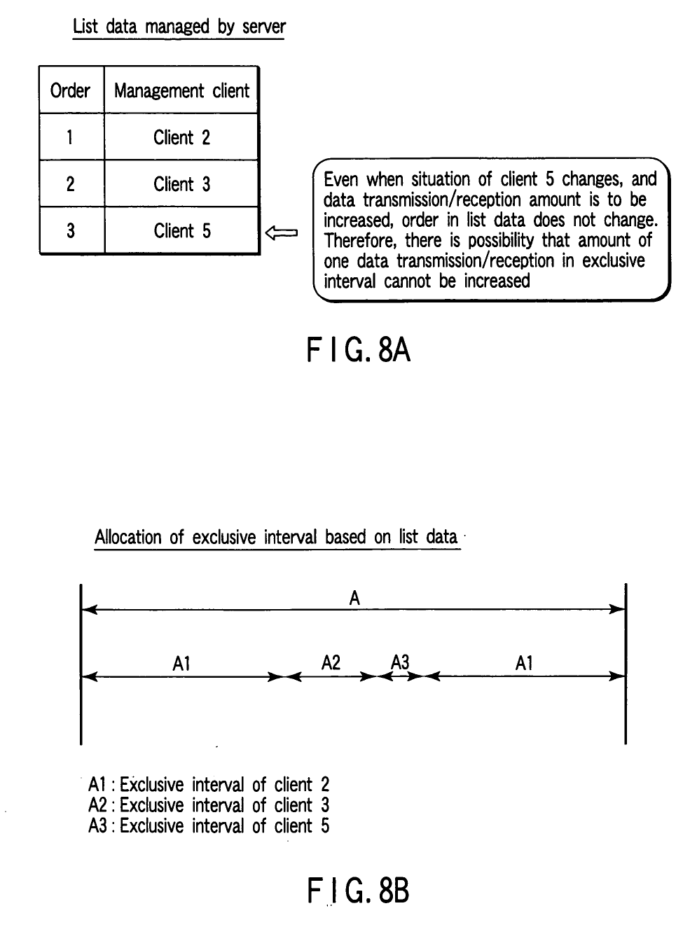

Now it is assumed that the priority order is set to the order of the client apparatuses 2, 3, 5 in the list data (major part) held by the server apparatus 10 as shown in FIG. 8A, and the exclusive interval is allocated to each client apparatus as shown in FIG. 8B.

Here, a case is considered in which the situation of the client apparatus 5 changes and a necessity of increasing the data transmission/reception amount occurs. In this case, the priority order in the list data has not heretofore been changed. Therefore, there has been a possibility that the data transmission/reception amount in one exclusive interval cannot be increased.

That is, a plurality of client apparatuses in the household which are different from one another in properties are connected to one network, and the list data once prepared is used as such in a fixed manner to transmit/receive the data between the server apparatus and client apparatus. In this case, it is considered that any change of the situation of the apparatus cannot appropriately be handled. For example, as shown in FIG. 8A, even when the situation of the client apparatus 5 positioned in the last place in the list data changes, and the data amount required to be transmitted/received with respect to the server apparatus increases, a large part of the exclusive interval is used by the client apparatus positioned in a superior place of the list data. There occurs possibility that the data amount that can be transmitted/received within a unit time by the client apparatus 5 cannot be increased.

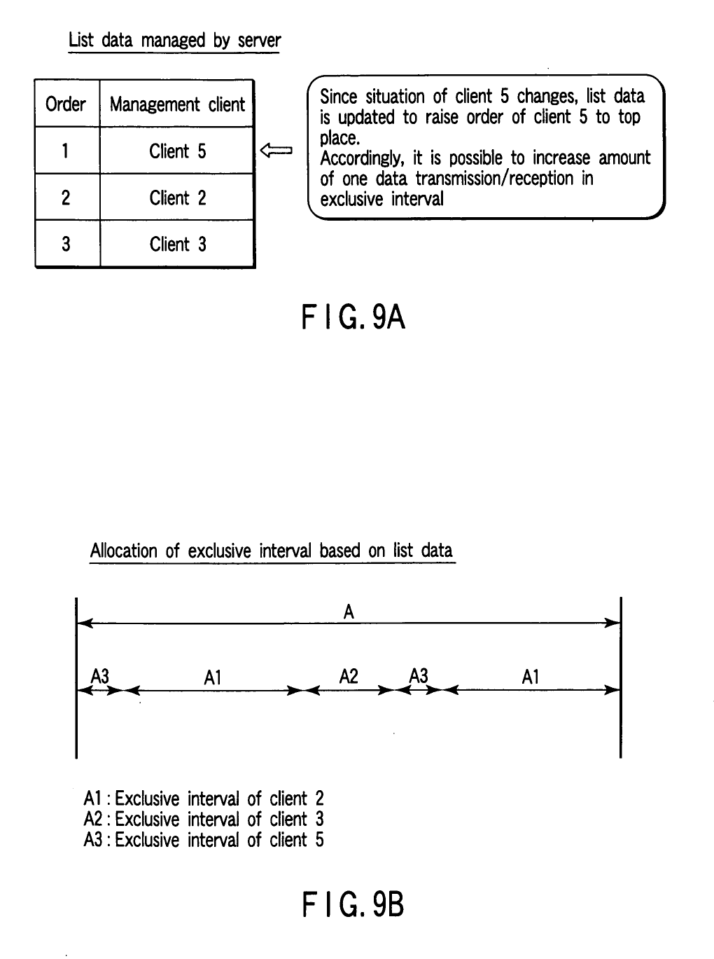

On the other hand, in the present embodiment, when the situation of the client apparatus 5 changes and it is necessary to increase the data transmission/reception amount, the server apparatus 10 updates the list data as shown in FIG. 9A using at least the situation data obtained from the client apparatus 5, and raises the priority order of the client apparatus 5. Accordingly, it is possible to increase the data transmission/reception amount in one exclusive interval. In this case, as seen from comparison with FIG. 8B, an exclusive interval A3 of the client apparatus 5 is entirely lengthened as shown in FIG. 9B and, for example, the exclusive interval Al of the client apparatus 2 is accordingly shortened.

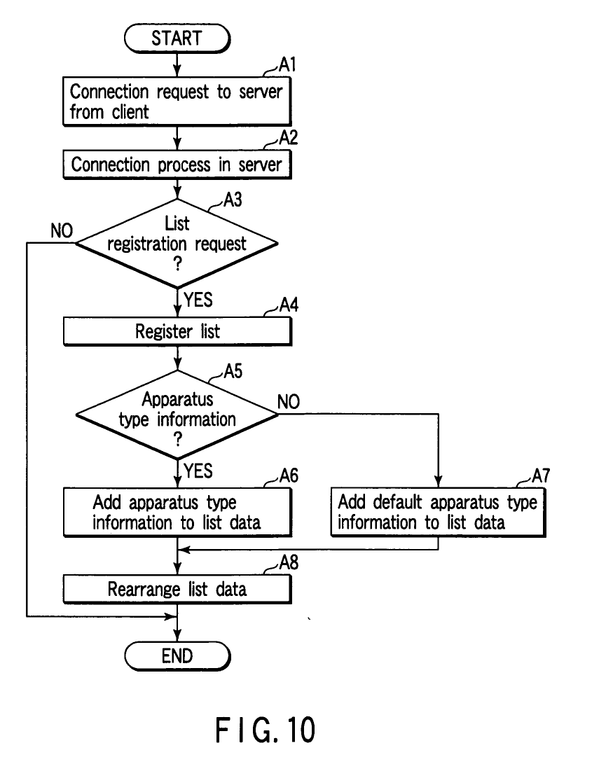

Next, a flow of a list data addition process in a connection process will be described with respect to a flowchart of FIG. 10.

One of the client apparatuses 1 to 5 performs a connection request with respect to the server apparatus 10 (step A1).

Accordingly, the server apparatus 10 performs a connection process with respect to the client apparatus that has made the connection request (step A2).

Here, the server apparatus 10 checks if there is a registration request into the list data from the client apparatus that has carried out the connection process (step A3).

When there is the registration request into the list data, the server apparatus 10 adds/registers the data of the client apparatus to be newly managed into the last of the list data (step A4). In the meantime, when there is not the registration request into the list data, the process is ended.

Moreover, the server apparatus 10 checks if the apparatus type information is transmitted from the client apparatus (step AS).

When the corresponding apparatus type information is transmitted to the client apparatus, the server apparatus 10 adds/registers the apparatus type information onto the list data (step A6). Note that, when the apparatus type information is not transmitted from the client apparatus, the apparatus type information of default set in the server apparatus 10 beforehand (e.g., “TYPE 3” shown in FIG. 6) is registered (step A7).

After the apparatus type information is added/registered, the server apparatus 10 rearranges the list data using the apparatus type information, situation data, and the like (step A8).

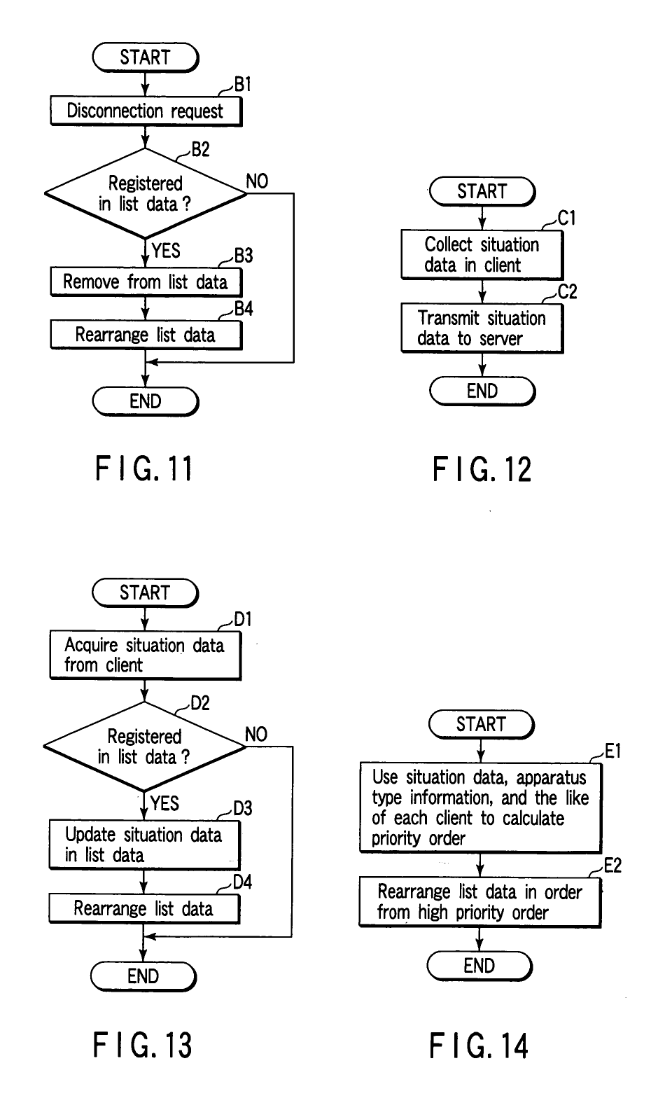

Next, a flow of a list data deletion process in a disconnection process will be described with reference to a flowchart of FIG. 11.

A disconnection request is made from one of the client apparatuses registered in the list data or the server apparatus 10 (step B1).

The server apparatus 10 checks if the client apparatus requiring disconnection is registered in the list data (step B2).

Here, when the client apparatus requiring disconnection is registered in the list data, the server apparatus 10 removes the data of the client apparatus from the list data (step B3). At this time, the server apparatus 10 performs actual disconnection of the client apparatus. Note that, when the client apparatus requiring disconnection is not registered in the list data, the process is ended.

After the data of the client apparatus is removed from the list data, the server apparatus 10 rearranges the list data using the apparatus type information, situation data, and the like (step B4).

Next, a flow of a situation data transmission process of the client apparatus will be described with reference to a flowchart of FIG. 12.

The client apparatus already registered in the list data collects the latest situation data in the client apparatus to be transmitted to the server apparatus in the client apparatus (step C1).

The client apparatus transmits the collected situation data to the server apparatus 10 (step C2).

Next, a flow of a situation data reception process of the server apparatus 10 will be described with reference to a flowchart of FIG. 13.

The server apparatus 10 receives the latest situation data transmitted from the client apparatus (step D1).

Here, the server apparatus 10 checks if the client apparatus that has transmitted the situation data is registered in the list data (step D2).

With the registration of the client apparatus that has transmitted the situation data into the list data, the server apparatus 10 reflects the situation data of the client apparatus received in the step D1 in the list data (step D3). Note that, when the client apparatus that has transmitted the situation data is not registered in the list data, the process is ended.

After reflecting the situation data in the list data, the server apparatus 10 rearranges the list data using the apparatus type information, situation data, and the like (step D4).

Next, a flow of an order change process of the list data will be described with reference to a flowchart of FIG. 14.

The server apparatus 10 calculates the priority order of each client apparatus according to a predetermined calculation equation, using the situation data of each client apparatus, and the information in the list data such as the apparatus type information (step E1).

The server apparatus 10 rearranges the list data so that the data of each client apparatus is arranged in order from a higher priority order calculated in the step E1 (step E2).

In this manner, in the present embodiment, when a change is generated in the data transmission/reception amount required by the client apparatus, the situation data of the client apparatus is transmitted to the server apparatus. The server apparatus that has received the latest situation data from the client apparatus updates the situation data of the client apparatus stored in the list data, and rearranges the list data. With the rearrangement of the list data, for example, the case shown in FIG. 9A in which the situation of the client apparatus 5 change and the necessary data transmission/reception amount increases can also flexibly be handled.

Several optimum rearrangement rules of the list data are considered. For example, there is considered a method of combining and obtaining a plurality of pieces of information such as the apparatus type information, importance for each apparatus type, latest apparatus situation (e.g., request rate), difference from the previous apparatus situation (e.g., difference between the previous request rate and the present request rate), the number of client apparatuses in the list data, and exclusive interval.

As described above in detail, according to the present invention, even when the situation of a client apparatus changes, the communication using the radio transmission medium can efficiently be performed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A server apparatus connectable to client apparatuses via a radio transmission medium, comprising:
a storage unit storing list data indicating a priority order of the client apparatuses in allocating an exclusive period thereto, the exclusive period being a period in which exclusive use of the radio transmission medium is permitted;
a control unit configured to allocate the exclusive period to the client apparatuses in accordance with the priority order indicated by the list data; and
a processing unit configured to rearrange the priority order of the client apparatuses on the list data using situation data indicating a situation of one of the client apparatuses, when the situation data is transmitted from the one.

2. The server apparatus according to claim 1, wherein the situation data includes data indicating a transfer rate required by the client apparatus.

3. The server apparatus according to claim 1, wherein the processing unit rearranges the priority order based on at least a combination of type data indicating a type of the client apparatus and the situation data.

4. The server apparatus according to claim 1, wherein the processing unit refers to a change of the situation data with time to rearrange the priority order.

5. The server apparatus according to claim 1, wherein the processing unit rearranges the priority order, when a certain client apparatus is registered or removed with respect to the list data.

6. A client apparatus connectable to a server apparatus via a radio transmission medium, comprising:
a permission request unit configured to request the server apparatus for permission of exclusive use of the radio transmission medium by the client apparatus; and
a situation notification unit configured to transmit situation data indicating a situation of one of the client apparatuses to the server apparatus, after the server apparatus admits the permission.

7. The client apparatus according to claim 6, wherein the situation data includes data indicating a transfer rate required by the client apparatus.

8. The client apparatus according to claim 6, wherein the situation notification unit transmits the situation data, when there is a change in the situation of one of the client apparatuses.

9. A communication control method for use in a server apparatus connectable to client apparatuses via a radio transmission medium, comprising:
storing in the server apparatus list data indicating a priority order of the client apparatuses in allocating an exclusive period thereto, the exclusive period being a period in which exclusive use of the radio transmission medium is permitted;
executing a control to allocate the exclusive period to the client apparatuses in accordance with the priority order indicated by the list data; and
rearranging the priority order of the client apparatuses on the list data using situation data indicating a situation of one of the client apparatuses, when the situation data is transmitted from the one.

10. The communication control method according to claim 9, wherein the situation data includes data indicating a transfer rate required by the client apparatus.

11. The communication control method according to claim 9, wherein the rearrangement of the priority order is carried out based on at least a combination of type data indicating a type of the client apparatus and the situation data.

12. The communication control method according to claim 9, wherein the rearrangement of the priority order is carried out in accordance with a change of the situation data with time.

13. The communication control method according to claim 9, wherein the rearrangement of the priority order is carried out, when a certain client apparatus is registered or removed with respect to the list data.
